(19) United States
(12) Patent Application Publication
(10) Pub. No.: US 2014/0126742 A1
(43) Pub. Date: May 8, 2014

(54) MULTI-ROOM AUDIO DISTRIBUTION SYSTEM HAVING A PLURALITY OF AUDIO CABLE ADAPTERS AND METHODS OF USE

(71) Applicant: JEFFREY G. EGGEBRAATEN, BOISE, ID (US)

(72) Inventor: JEFFREY G. EGGEBRAATEN, BOISE, ID (US)

(21) Appl. No.: 14/072,782

(22) Filed: Nov. 5, 2013

Related U.S. Application Data
(60) Provisional application No. 61/722,890, filed on Nov. 6, 2012.

(51) Int. Cl. H04R 3/12

(52) U.S. Cl. CPC H04R 3/12
USPC 381/80

(57) ABSTRACT

A multi-room audio distribution system 8 having a plurality of audio cable adapters that can be used to connect and distribute an electrical audio signal from an audio signal source 12, such as a personal computer to and through an unused telephone landline wired network 22 or a unused LAN (local area network or Ethernet) wired network to one or more audio receivers 18 such as an amplified speaker set, a stereo receiver, a headphones set, or another consumer electronic device each audio receiver having an audio input jack or a plurality of audio input jacks with the purpose of providing a means to play audio (music) from a single audio signal source on one or more of such audio receivers in one or more locations.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

Prior art for a multi-room audio distribution system (distributing music from one source in a building, home, or premises to a plurality of rooms) includes an installed speaker wire system in which a plurality of connecting speaker wires is installed into the intervening walls and/or ceilings of the building, home, or premises between a single audio signal source and a plurality of loudspeakers located in a plurality of locations with all of said loudspeakers powered by the audio signal source. The installed speaker wire system has disadvantages: (1) the number of speakers that can be used is limited by the amount of power the audio signal source can provide, (2) the installation of speaker wires in walls and ceilings can be expensive, and (3) the audio quality of the installed speaker wire system degrades over long runs of speaker wire.

Another prior art multi-room audio distribution system is an audio signal transmitter system having an audio signal transmitter which wirelessly transmits an audio signal to one or more speakers with each speaker having an integrated wireless receiver that processes the signal and powers the speaker. While the transmitter system allows for the use of many speakers in many locations from a single audio signal source without loss of sound quality, it is expensive and limits the choice of speakers to those having integrated wireless receivers.

Cell phones in our society are increasing in number and are supplanting preexisting wired networks (such as telephone landline networks) in buildings, homes, and premises. Similarly, domestic wireless internet networks are increasing in number and are supplanting preexisting LAN (local area networks) (Ethernet) wired networks. Yet, many buildings, homes, and premises are still being built with either or both a telephone landline wired network having a plurality of 6p6c or 6p4c or 6p2c modular jacks (RJ-11 style) and a LAN (Ethernet) wired network having a plurality of 8p8c modular jacks that may go unused by residents who prefer to utilize a cell phone or a wireless internet network.

The present invention provides a plurality of audio cable adapters and provides instruction on how to use the audio cable adapters to modify a preexisting unused multi-room landline wired network having a plurality of 6p2c, 6p4c, or 6p6c modular jacks or an unused multi-room LAN (Ethernet) wired network having a plurality of 8p8c modular jacks into a novel multi-room audio distribution system to convey an audio signal from a single audio signal source to one or more audio receivers in one or more rooms. A selected audio cable adapter connects an audio signal source to the wired network and one or more other audio cable adapters connect audio receivers to the wired network, thus providing a user with a novel multi-room audio distribution system. The present invention allows one or more audio receivers to run simultaneously from a single audio signal from a single low-power output device (audio signal source) such as a personal computer or an MP3 player or a comparable device, allows a user to select his own audio receiver or audio receivers and/or speakers and/or headphone sets, and allows the audio signal to be communicated from one end of a building, house, or premises wired network to the other end of the network without significant loss of audio quality.

### BRIEF SUMMARY OF THE INVENTION

The present invention is a multi-room audio distribution system 8 derived from a wired network of a building, home, or premises and includes a plurality of audio cable adapters. The multi-room audio distribution system 8 allows a user to choose an appropriate audio cable adapter from an array of audio cable adapters to enable an electrical audio signal from a single audio signal source 12 (such as a personal computer) to be selectively connected to and transmitted through an unused telephone landline wired network or an unused LAN (Ethernet) wired network and from the wired network to one or more selected audio receivers 18 (such as an amplified speaker set and/or a stereo receiver and/or a laptop computer having an audio play capability and/or a headphone set and/or a comparable device) with each audio receiver connected to the wired network by an appropriate selected audio cable adapter.

The preferred telephone landline wired network 22 has a plurality of modular jacks 24 (RJ-11 style) (6p4c) interconnected by four network conductors and preferably distributed in two or more rooms with each modular jack having said four network conductors respectively in positions 2, 3, 4, and 5 in a modular plug receiving cavity 26 for a cooperating electrical contact with a modular plug (RJ-11 style) (having either four conductors in positions 2, 3, 4, and 5 or two conductors in positions 3 and 4) of an appropriate audio cable adapter to be inserted therein.

A less preferred telephone landline wired network has a plurality of modular jacks 28 (RJ-11 style) (6p2c) interconnected and preferably distributed in two or more rooms with each modular jack having two conductors respectively in positions 3 and 4 in a modular plug receiving cavity 30 for cooperating electrical contact with a modular plug (RJ-11 style) (having either four conductors in positions 2, 3, 4, and 5 or two conductors in positions 3 and 4) of an appropriate audio cable adapter inserted therein.

If a telephone landline wired network encountered in a building, home, or premises has only two conductors in the plurality of modular jacks 28, then the electrical audio signal from an audio signal source will be limited to a monaural signal unless the connected audio signal source can output a digital signal through a selected plurality of digital audio cable adapters to and from the network to a digital audio receiver.

Another telephone landline wired network, a user may encounter in practicing the invention has a plurality of modular jacks 32 (RJ-11 style) (6p6c) interconnected and preferably distributed in two or more rooms with each telephone jack having six conductors respectively in positions 1, 2, 3, 4, 5, and 6 in a modular plug receiving cavity 34 for cooperating electrical contact with a modular plug (RJ-11 style) (having four conductors in positions 2, 3, 4, and 5 or three conductors in positions 2, 3, or 4 or two conductors in positions 3 and 4) of an appropriate audio cable adapter inserted therein.

A LAN (Ethernet) wired network embodiment of the invention has a plurality of LAN modular jacks 36 (RJ-45 style) (8p8c) interconnected and preferably distributed in two or more rooms with each LAN modular jack having eight conductors in positions 1, 2, 3, 4, 5, 6, 7, and 8 in a LAN modular plug receiving cavity 38 for cooperating electrical contact with a LAN modular plug of an audio cable adapter inserted therein.

Referring to FIG. 1, the physical structure of a best embodiment of the invention comprises: a plurality of TRS audio cable adapters 40, each said TRS audio cable adapter having four cable conductors and having two ends, a first end connected to a male TRS audio connector 42 (a TRS source or receiver connection assembly) having a tip 44, a ring 46, and, a sleeve 48 (preferably said TRS audio connector is a 3.5 mm TRS plug), and a second end connected to a modular plug 50 (preferably a (RJ-11 style) 6p4c modular plug having six positions and four conductors); an unused telephone landline wired network 22 having a plurality of interconnected modular jacks 24, each said modular jack is preferably a (RJ-11 style) 6p4c modular jack having six positions and four conductors in positions 2, 3, 4, and 5 of said six positions and each said modular jack shaped and configured to reversibly receive, retain, and cooperate with a plurality of said modular plugs; one of said TRS audio cable adapters connects an audio signal source to the network and one or more additional TRS audio cable adapters connect one or more audio receivers to the network whereby when an audio signal emanates from said audio signal source, said audio signal is communicated into and through said telephone landline wired network to said one or more audio receivers that can then be used to play the audio.

Another illustrative method of using the present invention comprises the following steps: connect operatively a TRS audio connector 42 (a TRS source or receiver connection assembly) of a first TRS audio cable adapter 40 to an electrical audio signal source (such as a personal computer 12 or an iPod or an MP3 player or a comparable device); connect operatively a modular plug 50 of said first TRS audio cable adapter into a modular jack 24 of an unused telephone landline wired network 22; connect a RCA audio cable adapter 52 having a modular plug 50 and having two RCA audio plugs 54 and 56 to any other modular jack of said wired network, and then connect said two RCA audio plugs to a set of RCA plug stereo inputs of an audio receiver (such as a stereo receiver 20) whereby when an audio signal emanates from said audio signal source, said audio signal is communicated into and through said telephone landline wired network to said audio receiver that can then be used to play the audio through a set of speakers or a set of headphones operatively connected to said audio receiver.

### BRIEF DESCRIPTION OF THE DRAWINGS

FIG. 1 is a semi-schematic, partially exploded diagram of a best embodiment of a multi-room audio distribution system 8 that incorporates a plurality of TRS audio cable adapters 40;

FIG. 2 is a semi-schematic, partially exploded diagram of a second embodiment showing a multi-room audio distribution system 8′ that incorporates a plurality of TRS audio cable adapters 40 and a RCA audio cable adapter 52 and a TRS socket audio cable adapter 62;

FIG. 3 is a semi-schematic diagram of the front of a 6p4c modular jack 24 having a modular plug receiving cavity 26 and having four network conductors respectively in positions 2, 3, 4, and 5 of said cavity for cooperating electrical contact with a modular plug inserted therein;

FIG. 4 is a semi-schematic diagram of the front of a 6p2c modular jack 28 having a modular plug receiving cavity 30 and having two network conductors respectively in positions 3 and 4 of said cavity for cooperating electrical contact with a modular plug inserted therein;

FIG. 5 is a semi-schematic diagram of the front of a 6p6c modular jack 32 having a modular plug receiving cavity 34 and having six network conductors respectively in positions 1, 2, 3, 4, 5, and 6 of said cavity for cooperating electrical contact with a modular plug inserted therein;

FIG. 6 is a semi-schematic diagram of the front of a 8p8c modular jack 36 having a modular plug receiving cavity 38 and having eight network conductors respectively in positions 1, 2, 3, 4, 5, 6, 7, and 8 of said cavity for cooperating electrical contact with a modular plug inserted therein;

FIG. 7 is a perspective view of a best embodiment of an audio cable adapter of the invention, a TRS audio cable adapter 40 having a TRS connector 42 (a TRS source or receiver connection assembly) having a tip 44, a ring 46, and a sleeve 48 at one end electrically connected by four cable conductors to a 6p4c modular plug 50 at the other end with said tip electrically connected to a cable conductor 3 in position 3 of said plug, said ring electrically connected to cable conductors 2 and 5 in positions 2 and 5 of said plug, and said sleeve electrically connected to a cable conductor 4 in position 4 of said plug;

FIG. 8 is a cross-sectional view of the TRS audio cable adapter 40 as viewed in direction 8-8 in FIG. 7;

FIG. 9 is a perspective view of a Y-shaped RCA audio cable adapter 52;

FIG. 10 is a cross-sectional view of the RCA audio cable adapter 52 as viewed in direction 10-10 in FIG. 9;

FIG. 11 is a perspective view of a TRS socket audio cable adapter 62;

FIG. 12 is a cross-sectional view of the TRS socket audio cable adapter 62 as viewed in direction 12-12 in FIG. 11;

FIG. 13 is a perspective view of a RCA digital audio cable adapter 72;

FIG. 14 is a cross-sectional view of the RCA digital audio cable adapter 72 as viewed in direction 14-14 in FIG. 13; and

FIG. 15 is a partially exploded, partial perspective view of an amplified speaker set 18 showing a TRS audio cable adapter 40 to be electrically and operatively connected to said amplified speaker set and showing in phantom lines a RCA digital audio cable adapter 72 that could be electrically and operatively connected to said amplified speaker set in an alternative digital audio signal embodiment of a multi-room audio distribution system having a plurality of RCA digital audio cable adapters.

### DETAILED DESCRIPTION OF THE INVENTION

A principal objective of the present invention is making available to users a multi-room audio distribution system that provides a means of sending an electrical audio signal from a single audio signal source through an unused preexisting landline telephone wired network or LAN (Ethernet) wired network to one or more audio receivers that is easy to use, easy to install in a building, a home, or a premises, is inexpensive to manufacture, and is more affordable for a user than other audio distribution systems.

The invention is a system comprising a selected plurality of novel audio cable adapters connected to an unused telephone landline wired network or LAN (Ethernet) wired network to distribute and communicate an electrical audio signal from a single audio signal source to one or more audio receivers.

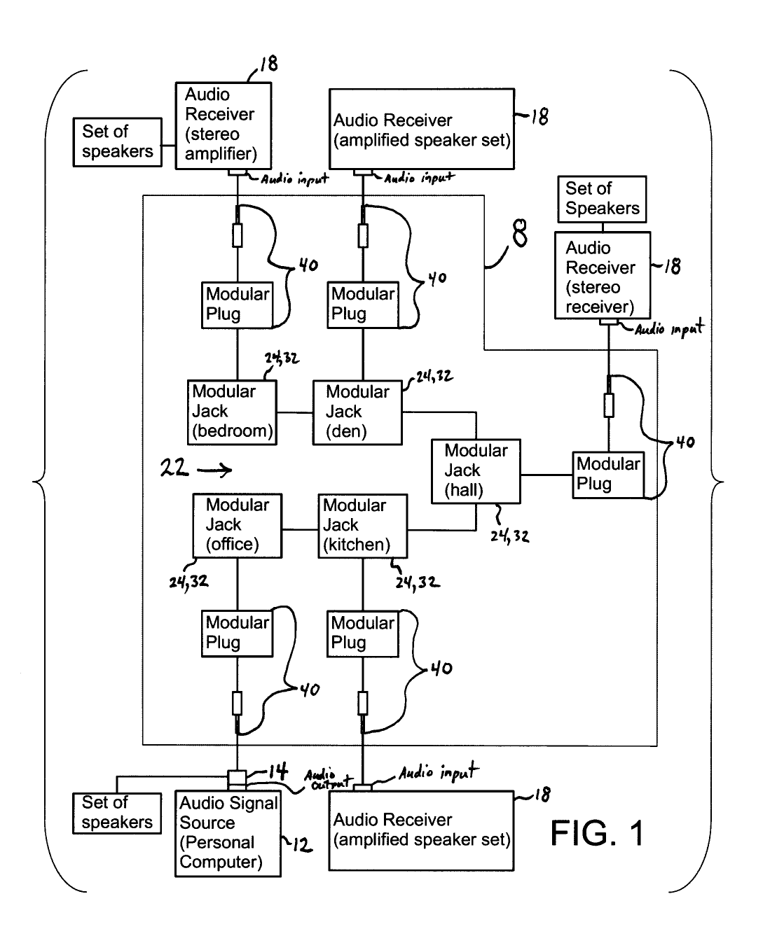

Referring to FIG. 1, an illustrative best embodiment of a multi-room audio distribution system 8 comprises an unused landline wired network 22, said wired network having a plurality of electrically and operatively interconnected modular jacks 24 (6p4c plugs) or 32 (6p6c plugs) distributed in a plurality of rooms; a plurality of TRS audio cable adapters 40 electrically and operatively connected respectively to two or more of said modular jacks; said system electrically and operatively interfacing between an audio signal source and one or more audio receivers whereby an audio signal is communicated between said signal source and said audio receivers.

Referring to FIG. 1, in operation, the audio distribution system electrically and operatively connects an audio signal source 12 (such as a personal computer that may also drive its own set of personal computer speakers through connecting cable to a TRS splitter adapter 14) to a first TRS audio cable adapter 40 of said system and one or more additional said TRS audio cable adapters of said distribution system respectively electrically and operatively connect to one or more audio receivers 18. In FIG. 1, the first TRS audio cable adapter is electrically and operatively connected to a first modular jack 24 or 32 of an unused telephone landline wired network 22; said wired network having a plurality of electrically and operatively connected 6p4c or 6p6c modular jacks 24 or 32; a second, a third, a fourth, and a fifth of said modular jacks are respectively electrically and operatively connected to a second, third, fourth, and fifth TRS audio cable adapter; each of said second, third, fourth, and fifth TRS audio cable adapters respectively electrically and operatively connected to four audio receivers 18 (via TRS audio input jacks of the receivers) such as two amplified speaker sets, a stereo receiver, or a stereo amplifier.

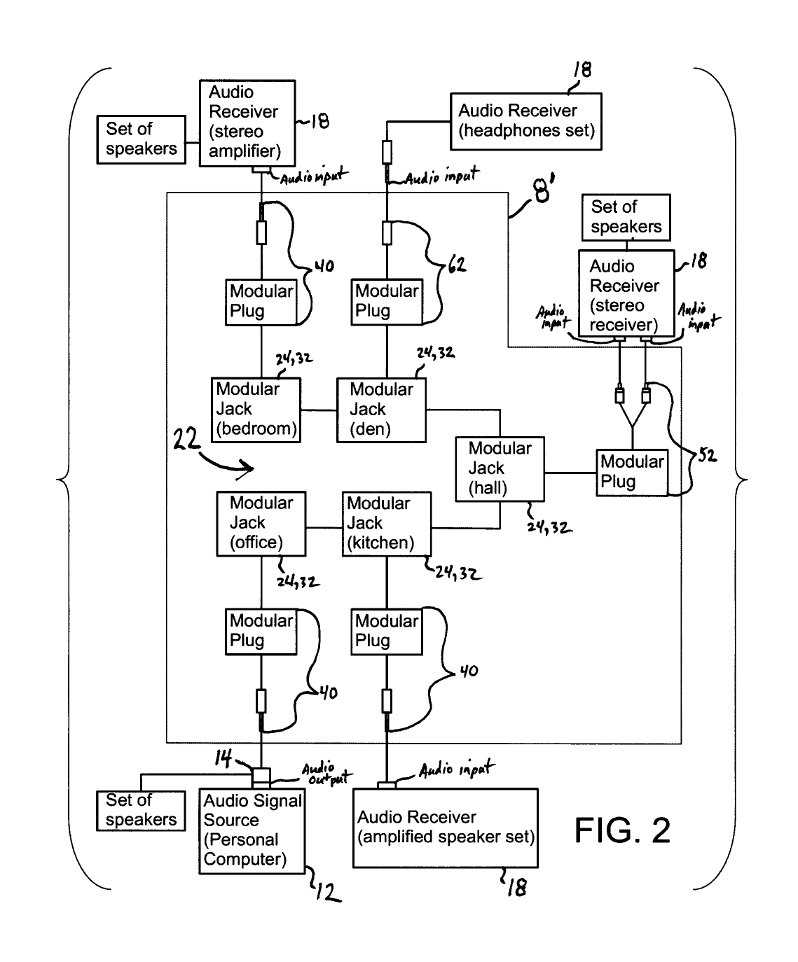

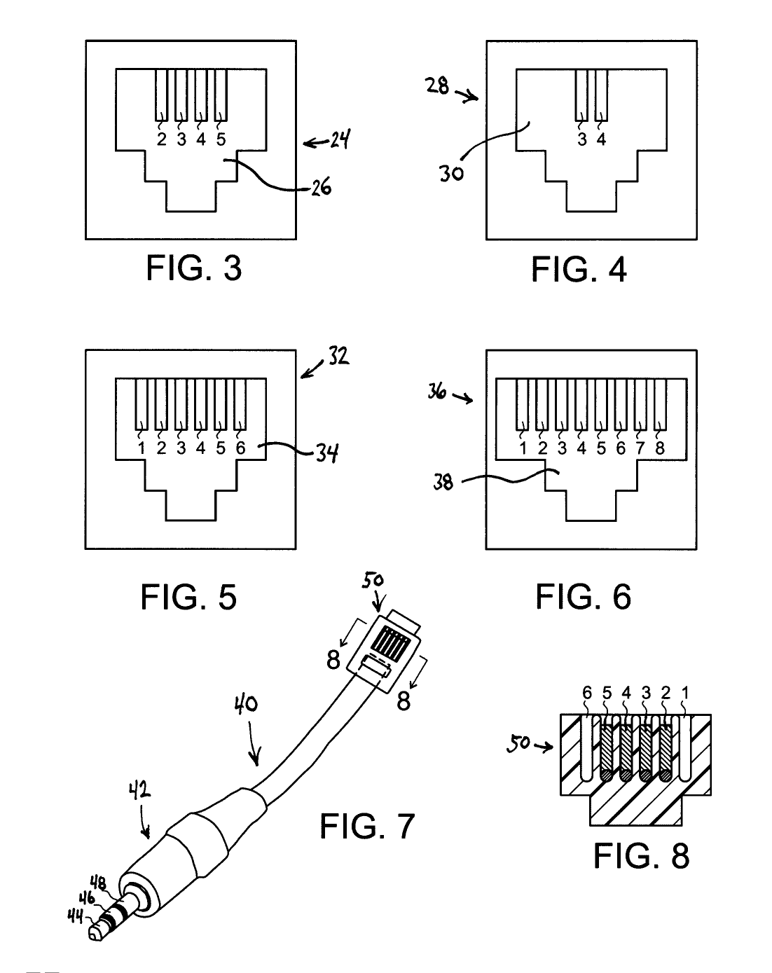

Referring to FIG. 2 (depicting an embodiment of a distribution system that is a modification of the embodiment shown in FIG. 1), an illustrative embodiment of an audio distribution system includes replacing said third TRS audio cable adapter of the FIG. 1 embodiment with a Y-shaped RCA audio cable adapter 52; said RCA audio cable adapter electrically and operatively connected to an audio receiver 18 (via RCA audio input jacks of the receiver) (such as a stereo receiver having a set of operatively attached speakers); and replacing said fourth TRS audio cable adapter of the FIG. 1 embodiment with a TRS socket audio cable adapter 62; said TRS socket audio cable adapter electrically and operatively connected to an audio receiver 18 (via a male TRS audio input of the receiver) (such as a headphones set).

Regarding use of a personal computer as an audio signal source, a user may choose to use an audio signal out splitter 14 that can be an electrical connector having a male TRS connector and two TRS female sockets to split an incoming audio signal into two outgoing audio signals.

Referring to FIGS. 7 and 8, a TRS audio cable adapter 40 comprises a TRS adapter electrical cable having a TRS adapter left wire (cable conductor), a TRS adapter right wire (cable conductor), and a TRS adapter ground wire (cable conductor); each said TRS adapter wire having two ends; the first end of said TRS adapter left wire connected to a tip 44 of a TRS audio plug 42 (TRS source or receiver assembly); the second end of said TRS adapter left wire preferably connected to a conductor 3 in position 3 of a 6p4c modular plug 50; the first end of said TRS adapter right wire connected to a ring 46 of said TRS audio plug; the second end of said TRS adapter right wire preferably connected to conductors 2 and 5 in positions 2 and 5 of said modular plug; the first end of said TRS adapter ground wire connected to a sleeve 48 of said TRS audio plug; and the second end of said TRS adapter ground wire preferably connected to a conductor 4 in position 4 of said modular plug.

An alternative embodiment of the TRS audio cable adapter comprises a TRS adapter electrical cable having a TRS adapter left wire (cable conductor), a TRS adapter right wire (cable conductor), and a TRS adapter ground wire (cable conductor); each said TRS adapter wire having two ends; the first end of said TRS adapter left wire connected to a tip of a TRS audio plug (TRS source or receiver connection assembly); the second end of said TRS adapter left wire preferably connected to a conductor 3 in position 3 of a 6p3c modular plug; the first end of said TRS adapter right wire connected to a ring of said TRS audio plug; the second end of said TRS adapter right wire preferably connected to a conductor 2 in position 2 of said modular plug; the first end of said TRS adapter ground wire connected to a sleeve of said TRS audio plug; and the second end of said TRS adapter ground wire preferably connected to a conductor 4 in position 4 of said modular plug.

For use in a system including a LAN (Ethernet) wired network, an alternative TRS audio cable adapter uses an 8p3c LAN (Ethernet) modular plug instead of a 6p3c plug and uses only three of the eight positions leaving the other four positions (1, 5, 6, 7, 8) of the LAN (Ethernet) modular plug unfilled.

For use with an audio signal source having two RCA plug outputs or with an audio receiver having two RCA plug inputs, an embodiment of the audio system includes one or more Y-shaped RCA audio cable adapter 52 having two arms and a leg and having two RCA connectors 54, 54′ each RCA connector respectively having a male tip 56, 60 and a female shield 58, 58′ (RCA source or receiver connection assembly), said RCA connectors respectively on said arms and electrically connected by four cable conductors to a 6p4c modular plug 50 on said leg with said male tip 56 electrically preferably connected to a conductor 3 in position 3 of said plug, said male tip 60 electrically and preferably connected to conductors 2 and 5 in positions 2 and 5 of said plug, and said female shields electrically and preferably connected to a conductor 4 in position 4 of said plug. The RCA audio cable adapter 52 can function as selectively connected to the distribution system as an RCA output adapter or an RCA input adapter.

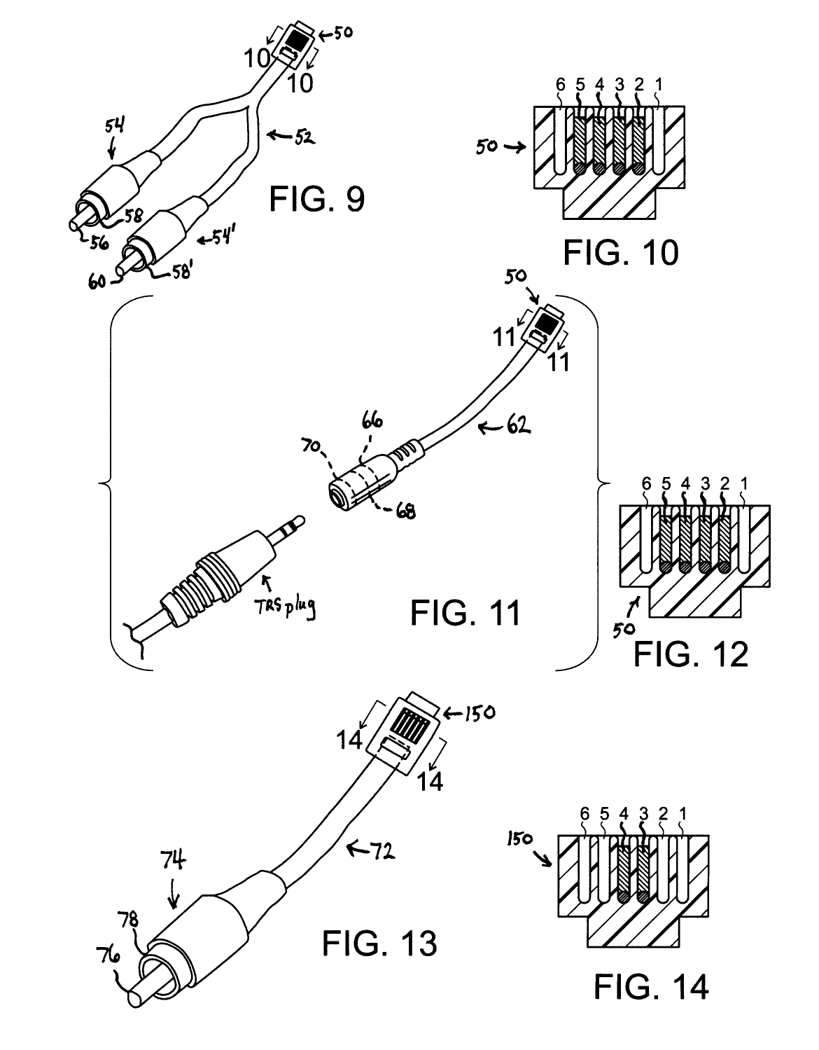

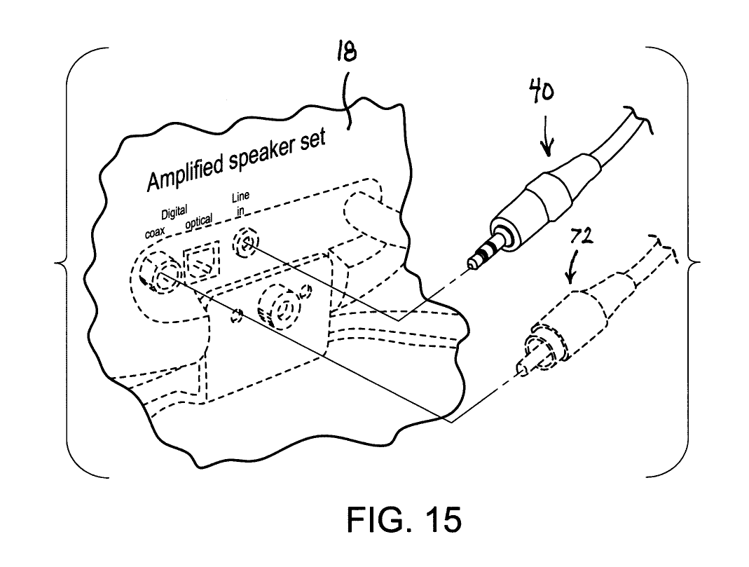

Referring to FIGS. 9 and 10, a RCA audio cable adapter 52 comprises a RCA adapter electrical cable; the RCA adapter electrical cable having a RCA adapter left wire (cable conductor), a RCA adapter right wire (cable conductor), and a RCA adapter ground wire (cable conductor); each RCA adapter wire having two ends; a first end of said RCA adapter left wire preferably connected to conductors 2 and 5 in positions 2 and 5 of a modular plug 50, a second end of the RCA adapter left wire connected to a male tip 60 of a RCA adapter RCA white plug 54′; a first end of the RCA adapter right wire preferably connected to a conductor 3 in position 3 of the modular plug; a second end of said RCA adapter right wire connected to a male tip 56 of a RCA adapter red RCA plug 54; and a first end of the RCA adapter ground wire preferably connected to a conductor 4 in position 4 of the modular plug; and a second end of the RCA adapter ground wire connected to a female shield 58, 58′ of each said RCA plugs.

For use in a system including a LAN (Ethernet) wired network, an alternative RCA audio cable adapter uses an 8p4c LAN (Ethernet) plug instead of a 6p4c plug and uses only four of the eight positions leaving the other four positions (1, 6, 7, 8) of the LAN (Ethernet) modular plug unfilled.

Referring to FIGS. 11 and 12, a TRS socket audio cable adapter 62 comprises a TRS socket adapter electrical cable; the TRS socket adapter electrical cable having a TRS socket adapter left wire (cable conductor), a TRS socket adapter right wire (cable conductor), and a TRS socket adapter ground wire (cable conductor); each TRS socket adapter wire having two ends; a first end of the TRS socket adapter left wire preferably connected to a conductor 3 in position 3 of a TRS socket adapter modular plug 50 (TRS socket source or receiver connection assembly); a second end of the TRS socket adapter left wire connected to a tip contactor 66 of a TRS socket adapter TRS socket connector 64; a first end of the TRS socket adapter right wire preferably connected to conductors 2 and 5 in positions 2 and 5 of said modular plug; a second end of the TRS socket adapter right wire connected to a ring contactor 68 of said TRS socket connector; a first end of the TRS socket adapter ground wire preferably connected to a conductor 4 in position 4 of said modular plug; and a second end of the TRS socket adapter ground wire connected to a sleeve contactor 70 of said TRS socket connector.

For use in a system including a LAN (Ethernet) wired network, an alternative TRS socket audio cable adapter uses an 8p4c LAN (Ethernet) plug instead of a 6p4c plug and uses only four of the eight positions and leaving the other four positions (1, 6, 7, 8) of the LAN (Ethernet) modular plug unfilled.

For use with an audio receiver (such as a headphones set) needing a female TRS socket connector (TRS socket source or receiver connection assembly), an embodiment of the system includes one or more TRS socket audio cable adapters 62, each said TRS socket audio cable adapter having a TRS socket connector 64 (TRS socket source or receiver connection assembly) having an internal tip contactor 66, an internal ring contactor 68, and an internal sleeve contactor 70 at one end electrically connected by four cable conductors to a 6p4c modular plug 50 at the other end with said tip contactor electrically and preferably connected to a conductor 3 in position 3 of said plug, said ring contactor electrically and preferably connected to conductors 2 and 5 in positions 2 and 5 of said plug, and said sleeve contactor electrically and preferably connected to a conductor 4 in position 4 of said plug. To connect a headphones set having a male TRS connector, a TRS socket audio cable adapter is connected between a modular jack of the distribution network and said male TRS connector of the headphones set.

Referring to FIGS. 13 and 14, a RCA digital audio cable adapter 72 comprises a RCA digital adapter electrical cable having a digital signal wire and a digital ground wire; each said digital signal and digital ground wire having two ends; a first end of the digital signal wire connected to a conductor 3 in position 3 of a RCA digital adapter modular plug 150; a second end of the digital signal wire connected to a male tip 76 of a digital RCA audio connector 74 (RCA digital source or receiver connection assembly); and a first end of the digital ground wire connected to a conductor 4 in position 4 of said modular plug; a second end of the digital ground wire connected to a female shield 78 of said digital RCA audio connector.

Referring to FIGS. 13 and 14, for use with an audio signal source having a digital RCA plug output and with at least one audio receiver having a digital RCA plug input, an embodiment of the distribution system includes a plurality of RCA digital audio cable adapters 72, each said RCA digital audio cable adapter having a RCA connector 74 (RCA digital source or receiver connection assembly) having a male tip 76 and a female shield 78 at one end electrically connected by two cable conductors to a 6p2c modular plug 150 at the other end with said male tip electrically connected to a conductor 3 in position 3 of said plug and said female shield electrically connected to a conductor 4 in position 4 of said plug. The RCA digital audio cable adapter can function as selectively connected as a digital output adapter or as a digital input adapter.

For use in a system including a LAN (Ethernet) wired network, an alternative RCA digital audio cable adapter uses an 8p2c LAN (Ethernet) plug instead of a 6p4c plug and uses only two of the eight positions leaving the other six positions (1, 2, 5, 6, 7, 8) of the LAN (Ethernet) modular plug unfilled.

Preferably, before incorporating an unused telephone landline wired network or LAN (Ethernet) wired network as a component of an audio distribution system, a user should confirm that the wired network is disconnected respectively from a telephone service provider or an internet service provider. Before a user makes use of the present invention, an unused telephone landline wired network or LAN (Ethernet) wired network is first either electrically disconnected or confirmed to be electrically disconnected from respectively a telephone service provider or an internet service provider at the point of interconnection to the provider's network so as to create in a building, home, or premises a plurality of interconnected modular jacks with no electrical connection to the telephone service provider or internet service provider. The present invention makes use of such an unused wired network having a plurality of interconnected modular jacks to carry an electrical audio signal from a selected and connected single audio signal source to one or more selected and connected audio receivers.

In a digital embodiment including a plurality of RCA digital audio cable adapter 72 and a digital audio signal, a user will connect a digital audio signal source to a modular jack of an unused landline wired network or LAN (Ethernet) wired network using a first RCA digital audio cable adapter, then connect one or more digital audio receivers to respectively one or more modular jacks on the network using respectively one or more RCA digital audio cable adapters. In the digital embodiment, a personal computer having a RCA digital output can be the digital audio signal source and each audio receiver connected to the system will have a RCA digital audio signal input, thus creating an affordable digital multi-room audio distribution system. Because the audio signal is transmitted digitally, there should be no decrease in sound quality when the digital audio signal source and the receiver or receivers are separated by long distances. Transmitting an audio signal digitally allows full multichannel audio to be transmitted on only two conductors.

If a user wants to communicate an analog audio signal through the system, then selected combinations of TRS, RCA, and/or TRS socket audio cable adapters can be used. An analog audio signal source can be a personal computer, a laptop computer, or a comparable device that can generate an analog audio signal. An audio receiver or audio receivers connected to the network by a respective audio cable adapter can be selected from among common consumer products such as stereo receivers, computer speakers, television audio inputs, headphones, theater systems, desktop computers, or any other device capable of receiving an analog audio signal. A user will connect the analog audio signal source to a modular jack of an unused landline wired network or LAN (Ethernet) wired network using an audio cable adapter, then the user will connect a selected one or more audio receivers to respective modular jacks of the network using a respective one or more audio cable adapters.

For all modular plugs used in all of the audio cable adapters, the ordering of the conductors could be selectively switched without affecting the usefulness of the invention, provided that the ordering of the conductors is consistent in all modular plugs. Because each audio cable adapter requires only two or three wires (a left wire and/or a right wire, and a ground wire), some conductors of the modular jacks may remain unused. The ordering of used and unused conductors of the modular jacks could be changed without affecting the usefulness of the invention, provided that the ordering is consistent in all modular jacks of the network.

The preceding description and exposition of a preferred embodiment of the invention is presented for purposes of illustration and enabling disclosure. It is neither intended to be exhaustive nor to limit the invention to the precise form disclosed. Modifications or variations in the invention in light of the above teachings that are obvious to one of ordinary skill in the art are considered within the scope of the invention as determined by the appended claims when interpreted to the breath to which they are fairly, legitimately and equitably entitled.

I claim:

1. A multi-room audio distribution system comprising
a wired network having a plurality of electrically and operatively interconnected modular jacks distributed to two or more rooms of a building;
a plurality of TRS audio cable adapters, each said audio cable adapter having a TRS connector at one end electrically and operatively connected to a modular plug at the other end, and each said modular plug electrically and operatively connected respectively to one of said modular jacks; and
a first of said TRS audio cable adapters electrically and operatively connected by its said TRS connector to an audio signal source; and
a second of said TRS audio cable adapters electrically and operatively connected by its said TRS connector to one audio receivers whereby an audio signal emanating from said audio signal source is communicated to said audio receiver.

2. A multi-room audio distribution system according to claim 1 wherein said modular jack is a 6p3c, 6p4c, or 6p6c (RJ-11 style) modular jack; and
wherein said modular plug is a 6p3c (RJ-11 style) modular plug.

3. A multi-room audio distribution system according to claim 1 wherein said modular jack is a 8p8c (RJ-45 style) modular jack; and
wherein said modular plug is a 8p3c (RJ-45 style) modular plug.

4. A multi-room audio distribution system comprising
a wired network having a plurality of electrically interconnected modular jacks distributed to two or more rooms of a building;
a plurality of audio cable adapters, each said audio cable adapter having a source or receiver connection assembly electrically and operatively connected to a modular plug, and each modular plug electrically and operatively connected respectively to one of said modular jacks;
a first of said audio cable adapters electrically and operatively connected by its said source or receiver connection assembly to an audio signal source; and
a second of said audio cable adapters electrically and operatively connected by its source or receiver connection assembly to an audio receiver whereby an audio signal emanating from said audio signal source is communicated to said audio receiver.

5. A multi-room audio distribution system according to claim 4 wherein said modular jack is a 6p3c, 6p4c, or 6p6c (RJ-11 style) modular jack;
wherein said audio cable adapter is a RCA audio cable adapter; and
wherein said modular plug is a 6p3c (RJ-11 style) modular plug.

6. A multi-room audio distribution system according to claim 4 wherein said modular jack is a 8p8c (RJ-45 style) modular jack;
wherein said audio cable adapter is a RCA audio cable adapter; and
wherein said modular plug is a 8p3c (RJ-45 style) modular plug.

7. A multi-room audio distribution system according to claim 4 wherein said modular jack is a 6p3c, 6p4c, or 6p6c (RJ-11 style) modular jack;
wherein said audio cable adapter is a TRS socket audio cable adapter; and
wherein said modular plug is a 6p3c (RJ-11 style) modular plug.

8. A multi-room audio distribution system according to claim 4 wherein said modular jack is an 8p8c (RJ-45 style) modular jack;
wherein said audio cable adapter is a TRS socket audio cable adapter; and
wherein said modular plug is a 8p3c (RJ-45 style) modular plug.

9. A multi-room audio distribution system according to claim 4 wherein said modular jack is a 6p3c, 6p4c, or 6p6c (RJ-11 style) modular jack;
wherein said audio cable adapter is a RCA digital audio cable adapter; and
wherein said modular plug is a 6p2c (RJ-11 style) modular plug.

10. A multi-room audio distribution system according to claim 4 wherein said modular jack is an 8p8c (RJ-45 style) modular jack;
wherein said audio cable adapter is a RCA digital audio cable adapter; and
wherein said modular plug is a 8p2c (RJ-45 style) modular plug.

11. A TRS audio cable adapter electrically and operatively connecting an audio signal source having a TRS audio signal source jack or an audio receiver having a TRS audio receiver jack to a wired network having a modular jack comprising:
a modular plug having a left cable conductor, a right cable conductor, and a ground cable conductor;
a TRS connector having a tip electrically and operatively connected to said left cable conductor, a ring electrically and operatively connected to said right cable conductor, and a sleeve electrically and operatively connected to said ground cable conductor.

12. A TRS audio cable adapter according to claim 11 wherein said modular plug is a 6p3c (RJ-11 style) modular jack.

13. A TRS audio cable adapter according to claim 11 wherein said modular plug is a 8p3c (RJ-45 style) modular jack.
